(19) United States
(12) Patent Application Publication
(10) Pub. No.: US 2025/0239600 A1
(43) Pub. Date: Jul. 24, 2025

(54) SILICON ANODE ELECTRODE WITH ACTIVE MATERIAL PARTICLES COATED WITH SOLID ELECTROLYTE FOR SOLID-STATE BATTERY CELLS

(71) Applicant: GM GLOBAL TECHNOLOGY OPERATIONS LLC, Detroit, MI (US)

(72) Inventors: Qili SU, Shanghai (CN); Zhe LI, Shanghai (CN); Meiyuan WU, Shanghai (CN); Haijing LIU, Shanghai (CN)

(21) Appl. No.: 18/596,800

(22) Filed: Mar. 6, 2024

(30) Foreign Application Priority Data
Jan. 18, 2024 (CN) 202410078032.7

(51) Int. Cl. H01M 4/38; H01M 4/02; H01M 4/04; H01M 4/36; H01M 4/62

(52) U.S. Cl. CPC H01M 4/386; H01M 4/0404; H01M 4/366; H01M 4/623; H01M 2004/021; H01M 2004/027; H01M 2300/0068

(57) ABSTRACT

An anode electrode for a battery cell includes an anode active material layer. The anode active material layer includes an anode active material and an outer coating layer covering at least a portion of an outer surface of particles of the anode active material layer. The outer coating layer includes a solid electrolyte and a fibrillating binder.

### CROSS-REFERENCE TO RELATED APPLICATIONS

This application claims the benefit of Chinese Patent Application No. 202410078032.7, filed on Jan. 18, 2024. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to silicon anode electrodes with active material particles coated with solid electrolyte for solid-state battery cells.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

Battery cells include cathode electrodes, anode electrodes, and separators. The cathode electrodes include a cathode active material layer arranged on a cathode current collector. The anode electrodes include an anode active material layer arranged on an anode current collector.

### SUMMARY

An anode electrode for a battery cell includes an anode active material layer. The anode active material layer includes an anode active material and an outer coating layer covering at least a portion of an outer surface of particles of the anode active material layer. The outer coating layer includes a solid electrolyte and a fibrillating binder.

In other features, the anode active material layer is arranged on an anode current collector. The fibrillating binder comprises polytetrafluoroethylene (PTFE). The anode active material is selected from a group consisting of silicon, silicon alloy, and silicon/silicon oxide. A softening point of the fibrillating binder is in a range from 270° C. to 380° C. A molecular weight of the fibrillating binder is in a range from 105 g/mol to 109 g/mol.

In other features, loading of the anode active material layer is in a range from 4 mAh/cm² to 30 mAh/cm². A thickness of the anode active material layer is in a range from 10 μm to 200 μm. The solid electrolyte is selected from a group consisting of sulfide-based solid electrolyte, halide-based solid electrolyte, and hydride-based solid electrolyte. The solid electrolyte comprises sulfide solid electrolyte. The sulfide solid electrolyte is selected from a group consisting of pseudobinary sulfide, pseudoternary sulfide, and pseudoquaternary sulfide. The anode active material layer comprises 70 wt % to 98 wt % of the anode active material layer, the solid electrolyte comprises 2 wt % to 30 wt % of the anode active material layer, and the fibrillating binder comprises 0.1 wt % to 5 wt % of the anode active material layer.

An anode electrode for a battery cell includes an anode current collector and an anode active material layer arranged on the anode current collector. The anode active material layer includes an anode active material selected from a group consisting of silicon, silicon alloy, and silicon/silicon oxide. An outer coating layer covers at least a portion of an outer surface of particles of the anode active material layer. The outer coating layer includes a solid electrolyte selected from a group consisting of sulfide-based solid electrolyte, halide-based solid electrolyte, and hydride-based solid electrolyte. A fibrillating binder includes polytetrafluoroethylene (PTFE).

In other features, loading of the anode active material layer is in a range from 4 mAh/cm² to 30 mAh/cm². A thickness of the anode active material layer is in a range from 10 μm to 200 μm. The solid electrolyte comprises sulfide solid electrolyte. The sulfide solid electrolyte is selected from a group consisting of pseudobinary sulfide, pseudoternary sulfide, and pseudoquaternary sulfide. The anode active material layer comprises 70 wt % to 98 wt % of the anode active material layer, the solid electrolyte comprises 2 wt % to 30 wt % of the anode active material layer, and the fibrillating binder comprises 0.1 wt % to 5 wt % of the anode active material layer.

A method for manufacturing anode electrode for a battery cell includes mixing and milling a pre-mixture including particles of an anode active material selected from a group consisting of silicon, silicon alloy, and silicon/silicon oxide, and particles of a solid electrolyte selected from a group consisting of sulfide-based solid electrolyte, halide-based solid electrolyte, and hydride-based solid electrolyte. The particles of the solid electrolyte at least partially coat the particles of the anode active material. The method includes adding a fibrillating binder to the pre-mixture; mixing and shearing the pre-mixture to create fibrils of the fibrillating binding and to create a mixture for an anode active material layer; and one of pressing the mixture to create a free-standing anode active material layer, and casting the mixture onto an anode current collector to form the anode active material layer of the anode electrode.

In other features, the solid electrolyte comprises sulfide solid electrolyte. The sulfide solid electrolyte is selected from a group consisting of pseudobinary sulfide, pseudoternary sulfide, and pseudoquaternary sulfide. The anode active material layer comprises 70 wt % to 98 wt % of the anode active material layer, the solid electrolyte comprises 2 wt % to 30 wt % of the anode active material layer, and the fibrillating binder comprises 0.1 wt % to 5 wt % of the anode active material layer.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross section of an example of a solid-state battery cell including anode electrodes, cathode electrodes, and separators according to the present disclosure;

FIG. 2 is a side cross section of an example of a cathode electrode according to the present disclosure;

FIG. 3A is a side cross section of an example of an anode electrode before formation according to the present disclosure;

FIG. 3B is a side cross section of the anode electrode of FIG. 3A after formation according to the present disclosure;

FIGS. 3C and 3D are side cross sections showing different examples of morphology of particles of anode active material according to the present disclosure;

FIG. 4 is a flowchart of an example of a method for manufacturing a cathode electrode according to the present disclosure;

FIG. 5 is a scanning electron microscope image of an example of an anode electrode including silicon active material and a fibrillating binder;

FIG. 6 is a scanning electron microscope image of an example of an anode electrode including silicon active material coated with sulfide solid electrolyte and a fibrillating binder according to the present disclosure;

FIG. 7 is a graph illustrating voltage as a function of specific capacity for a conventional anode electrode and an anode electrode including silicon active material coated with solid electrolyte and a fibrillating binder according to the present disclosure; and

FIG. 8 is a graph illustrating capacity as a function of cycles for a conventional anode electrode and an anode electrode including silicon active material coated with solid electrolyte and a fibrillating binder according to the present disclosure.

In the drawings, reference numbers may be reused to identify similar and/or identical elements.

### DETAILED DESCRIPTION

While battery cells according to the present disclosure are shown in the context of electric vehicles, the battery cells can be used in stationary applications and/or other applications.

A dry manufacturing process may be used to manufacture anode electrodes. Unlike wet processes, dry processes do not use solvents and do not require manufacturing equipment or floor space for a drying stage. For example, silicon anode electrodes made using the dry process include an anode active material layer arranged on an anode current collector. The anode active material includes particles of silicon that are mixed/sheared with a fibrillating binder such as PTFE, cast onto an anode current collector, and calendared (or manufactured as a free-standing film on a removable substrate and laminated onto an anode current collector). However, using the PTFE binder reduces the performance of the anode electrode due to side reactions. The side reactions between the LiₓSi compounds and the PTFE binder led to high reversible capacity and poor initial columbic efficiency (e.g., 15% to 20% reduction compared to silicon powder without binder). The side reaction is as follows:

2nLixSi+x[-CF2-]n (PTFE)→2nx LiF+2nSi+nx C (amorphous)

More particularly, the side reaction between LiₓSi compounds and the PTFE binder consumes active lithium within the anode electrode, which reduces battery cell performance. The side reaction does not happen only at contact points of the LiₓSi compounds and the PTFE binder. The PTFE binder is fully reduced within the solid state battery due to electrode expansion. As can be appreciated, the side reactions should be significantly reduced or prevented to enable dry film silicon anode electrodes.

An anode electrode according to the present disclosure is prepared by coating particles of anode active material (e.g., silicon) with a solid electrolyte (e.g., sulfide solid electrolyte). For example, the particles of the anode active material and the solid electrolyte are pre-mixed and milled to coat the active material with the solid electrolyte. Then, the coated anode active material is mixed/sheared with a fibrillating binder (e.g., PTFE) to created fibrils. The mixture is pressed and calendared to form the anode active material layer as a flexible, continuous dry film (or cast directly onto the anode current collector). If cast as a free-standing film, the anode active material layer is laminated onto an anode current collector.

The solid electrolyte coating inhibits LiₓSi/PTFE side reactions and increases favorable lithium-ion transport in the anode electrode. As a result, the anode electrodes deliver high initial columbic efficiency and high initial discharge capacity with stable cell cycling.

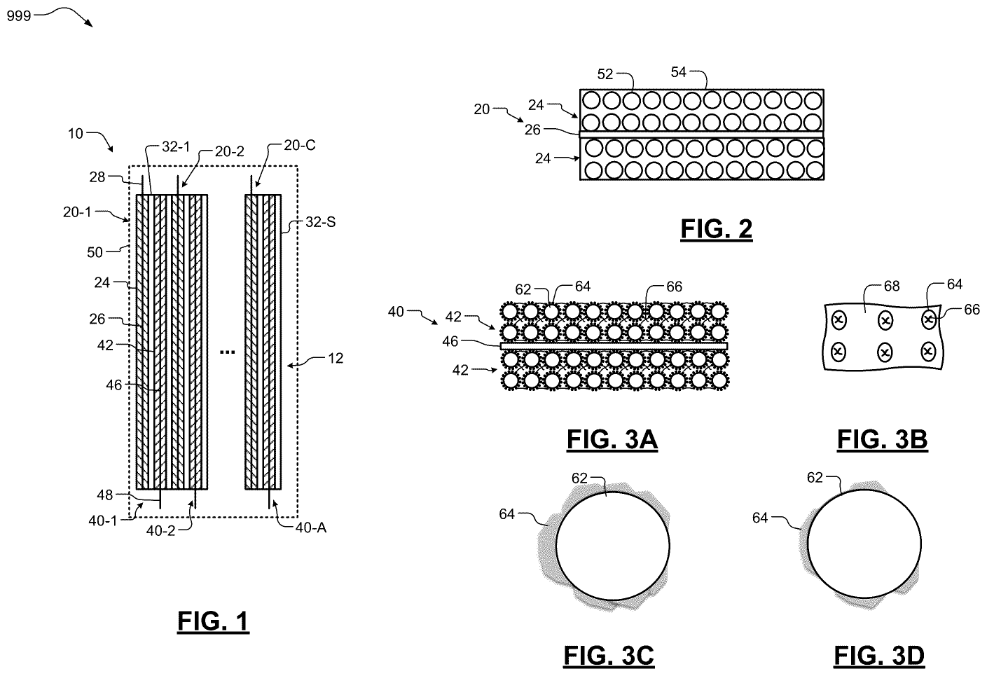

Referring now to FIG. 1, a battery cell 10 includes C cathode electrodes 20, A anode electrodes 40, and S separators 32 arranged in a predetermined sequence in a battery cell stack 12, where C, S and A are integers greater than zero. The battery cell stack 12 is arranged in an enclosure 50. The C cathode electrodes 20-1, 20-2, . . . , and 20-C include cathode active material layers 24 arranged on one or both sides of a cathode current collector 26.

The A anode electrodes 40-1, 40-2, . . . , and 40-A include anode active material layers 42 arranged on one or both sides of the anode current collectors 46. During charging/discharging, the A anode electrodes 40 and the C cathode electrodes 20 exchange lithium ions.

In some examples, the cathode current collector 26 and/or the anode current collector 46 comprise metal foil, metal mesh, perforated metal, 3 dimensional (3D) metal foam, and/or expanded metal. In some examples, the current collectors are made of one or more materials selected from a group consisting of copper, stainless steel, brass, bronze, zinc, aluminum, and/or alloys thereof. External tabs 28 and 48 are connected to the current collectors of the cathode electrodes and anode electrodes, respectively, and can be arranged on the same or different sides of the battery cell stack 12. The external tabs 28 and 48 are connected to terminals of the battery cells.

Referring now to FIG. 2, one of the C cathode electrodes 20 is shown before formation in further detail. The cathode active material layer 24 of the C cathode electrodes 20 includes a mixture of cathode active material 52 and sulfide solid electrolyte 54. In some examples, the cathode active material layer 24 further includes a fibrillating binder and/or a conductive filler (both not shown).

Referring now to FIG. 3A, one of the A anode electrodes 40 is shown before formation (lithiation of the silicon) in further detail. The anode active material layer 42 of the anode electrode 40 includes anode active material 62. The anode active material 62 is selected from a group consisting of silicon, silicon alloy (e.g., a lithium alloying metal such as aluminum (Al), tin (Sn), magnesium (Mg), etc.), and silicon/silicon oxide (Si/SiOₓ). Particles of the anode active material 62 are mixed with the solid electrolyte and milled to partially coat or to fully coat an outer surface of the particles of anode active material with a solid electrolyte 64 (e.g., sulfide). The coated anode active material is mixed/sheared with a fibrillating binder 66 before calendaring.

In some examples, the fibrillating binder comprises polytetrafluoroethylene (PTFE). In some examples, the fibrillating binder has a particle size in a range from 100 μm to 800 μm. In some examples, the fibrillating binder has a particle size in a range from 300 μm to 700 μm. In some examples, the weight ratio of the fibrillating binder to the anode active material layer is in a range from 0.01:100 to 20:100 (e.g., 0.05:100). In some examples, the softening point of the fibrillating binder is in a range from 270 to 380° C. In some examples, the molecular weight of the fibrillating binder is in a range from 105 g/mol to 109 g/mol. In some examples, water is fully removed before using.

In FIG. 3B, one of the A anode electrodes 40 is shown after formation in further detail. After formation, the A anode electrodes 40 include lithiated anode active material (e.g., LiₓSi) that merges together under pressure as shown at 68. The fibrils of the fibrillating binder 66 are mostly encapsulated within the solid electrolyte 64.

In FIG. 3C, the solid electrolyte 64 can have a continuous morphology on an outer surface of the particles the anode active material 62. In FIG. 3D, the solid electrolyte 64 can have a discontinuous morphology on the outer surface of the particles the anode active material 62. As can be appreciated, because the fibrillating binder tends to adhere to the solid electrolyte 64, the coating does not need to fully cover the anode active material to significantly reduce the side reactions.

The dry film process described herein eliminates the use of organic solvents and simplifies the electrode fabrication process by removing the conventional drying step. The solvent-free dry film process circumvents the influence of the solvent on the Li-ion conduction in the solid electrolyte and enables good electrochemical performance for a high energy anode electrode.

In some examples, the anode active material layer 42 comprises the anode active material, the sulfide solid electrolyte (coating the anode active material), and the fibrillating binder. In some examples, the anode active material comprises 70 wt % to 98 wt % of the anode active material layer, the solid electrolyte comprises 2 wt % to 30 wt % of the anode active material layer, and the fibrillating binder comprises 0.1 wt % to 5 wt % of the anode active material layer (e.g., a 70:29:1 wt % ratio). In some examples, loading of the anode active material layer is in a range from 4 mAh/cm² to 30 mAh/cm². In some examples, a thickness of the anode active material layer is in a range from 10 μm to 200 μm.

In some examples, the solid electrolyte has low electronic conductivity and high Li-ion conductivity to prevent side reactions. The solid electrolyte provides a rough/deformable surface to promote binder fibrilization. The solid electrolyte coating blocks side reactions between LiₓSi and PTFE by encapsulating the PTFE within the solid electrolyte. The solid electrolyte builds up favorable lithium-ion transport within the lithiated silicon (LiₓSi). The particles of anode active material provide high capacity and expand to form a compact anode electrode. The fibrils of the binder adhere particles together like a “spider web” to form the dry film.

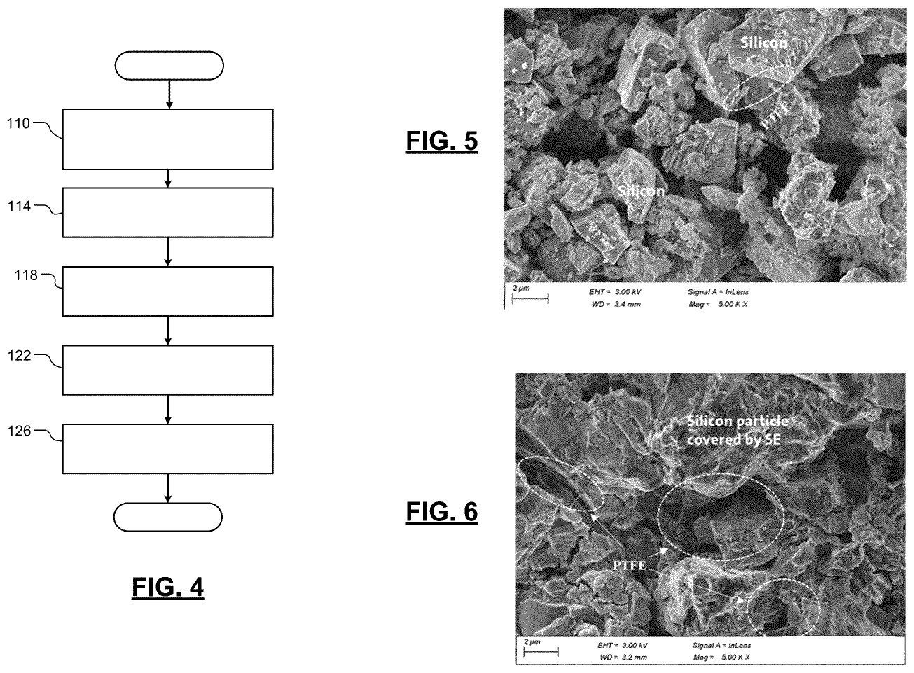

Referring now to FIG. 4, a flowchart of an example of a method for manufacturing a cathode electrode is shown. At 110, particles of the anode active material (e.g., silicon) and solid electrolyte particles (e.g., sulfide solid electrolyte) are pre-mixed and milled to coat the particles of active material. At 114, a fibrillating binder such as PTFE is added to the mixture. At 118, the mixture is mixed and sheared to fibrillate the fibrillating binder and create fibrils. At 122, the mixture forming the anode active material layer is pressed and/or heated to form a dry film. At 126, the anode active material layer is laminated onto an anode current collector. Alternately, the active material layer can be cast directly onto an anode current collector and steps 122 and 126 can be omitted.

Referring now to FIGS. 5 and 6, scanning electron microscope images of a conventional anode electrode (at 310) and an anode electrode according to the present disclosure (at 314) are shown. In FIG. 5, the conventional anode electrode includes 99 wt % silicon active material (that is not coated with sulfide solid electrolyte) and 1 wt % fibrillating binder. Since the outer surface of the particles of silicon are relatively smooth and hard, less fibrillation of the binder occurs as compared to FIG. 6.

In FIG. 6, an anode electrode including silicon active material (e.g., 70 wt %) is coated with sulfide solid electrolyte (e.g., 29 wt %) and mixed/sheared with a fibrillating binder (e.g., 1 wt %). Silicon particles are partially or fully coated by solid electrolyte (e.g., sulfide solid electrolyte). As can be seen in FIG. 6, the sulfide solid electrolyte with the deformable surface provides more adhesion sites for building up more fibrils in the dry-film electrode. The PTFE fibrils interconnect between the solid electrolyte to form the dry film.

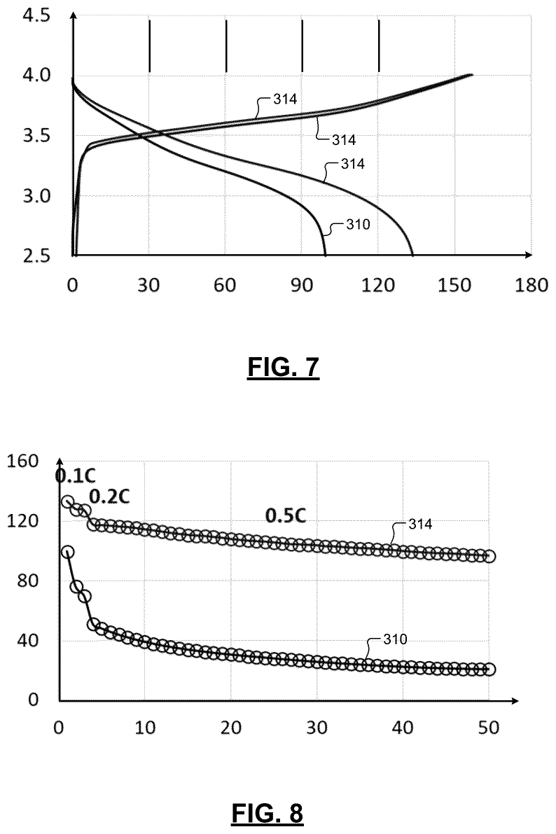

Referring now to FIGS. 7 and 8, the performance of the anode electrode including silicon active material coated with sulfide solid electrolyte and the fibrillating binder outperforms the conventional anode electrode. In FIG. 7, first cycle performance (e.g., at 0.1 C and room temperature) of the coated anode electrode (at 314) is compared with the conventional anode (at 310). In FIG. 8, capacity is shown as a function of cycles.

In some examples, the solid electrolyte is selected from a group consisting of sulfide-based solid electrolyte, halide-based solid electrolyte, hydride-based solid electrolyte, and other solid electrolytes that have low grain-boundary resistance. In some examples, the sulfide solid electrolyte is selected from a group consisting of pseudobinary sulfide, pseudoternary sulfide, and pseudoquaternary sulfide. Examples of halide-based solid electrolyte include Li₃YCl₆, Li₃InCl₆, Li₃YBr₆, LiI, Li₂CdCl₄, Li₂MgCl₄, Li₂CdI₄, Li₂ZnI₄, Li₃OCl, and combinations thereof. Examples of hydride-based solid electrolyte include LiBH₄, LiBH₄—LiX (where X=chlorine (Cl), bromine (Br) or iodine (I)), LiNH₂, Li₂NH, LiBH₄—LiNH₂, Li₃AlH₆, and combinations thereof.

Examples of pseudobinary sulfide include Li₂S—P₂S₅ system (Li₃PS₄, Li₂P₃S₁₁ and Li_{9.6}P₃S₁₂), Li₂S—SnS₂ system (Li₄SnS₄), Li₂S—SiS₂ system, Li₂S—GeS₂ system, Li₂S—B₂S₃ system, Li₂S—Ga₂S₃ system, Li₂S—P₂S₃ system, and Li₂S—Al₂S₃ system. Examples of pseudoternary sulfide include Li₂O—Li₂S—P₂S₅ system, Li₂S—P₂S₅—P₂O₅ system, Li₂S—P₂S₅—GeS₂ system (Li_{3.25}Ge_{0.25}P_{0.75}S₄ and Li₁₀GeP₂S₁₂), Li₂S—P₂S₅—LiX (X=F, Cl, Br, I) system (Li₃PS₅Br, Li₃PS₅Cl, L₇P₂S₈I and Li₄PS₄I), Li₂S—As₂S₅—SnS₂ system (Li_{3.833}Sn_{0.833}As_{0.166}S₄), Li₂S—P₂S₅—Al₂S₃ system, Li₂S—LiX—SiS₂ (X=F, Cl, Br, I) system, 0.4LiI-0.6Li₄SnS₄, Li₁₁Si₂PS₁₂, and combinations thereof.

Examples of pseudoquaternary sulfide include Li₂O—Li₂S—P₂S₅—P₂O₅ system, Li_{9.54}Si_{1.74}P_{1.44}S_{11.7}Cl_{0.3}, Li₂P_{2.9}Mn_{0.1}S_{10.7}|_{0.3} and Li_{10.35}[Sn_{0.27}Si_{1.08}]P_{1.65}S₁₂. Examples of halide-based solid electrolyte include Li₃YCl₆, Li₃InCl₆, Li₃YBr₆, LiI, Li₂CdCl₄, Li₂MgCl₄, Li₂CdI₄, Li₂ZnI₄, Li₃OcI, and combinations thereof.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. An anode electrode for a battery cell, comprising:
an anode active material layer comprising:
an anode active material;
an outer coating layer covering at least a portion of an outer surface of particles of the anode active material layer,
wherein the outer coating layer includes a solid electrolyte; and
a fibrillating binder.

2. The anode electrode of claim 1, wherein the anode active material layer is arranged on an anode current collector.

3. The anode electrode of claim 1, wherein the fibrillating binder comprises polytetrafluoroethylene (PTFE).

4. The anode electrode of claim 1, wherein the anode active material is selected from a group consisting of silicon, silicon alloy, and silicon/silicon oxide.

5. The anode electrode of claim 1, wherein a softening point of the fibrillating binder is in a range from 270° C. to 380° C.

6. The anode electrode of claim 1, wherein a molecular weight of the fibrillating binder is in a range from 105 g/mol to 109 g/mol.

7. The anode electrode of claim 1, wherein loading of the anode active material layer is in a range from 4 mAh/cm² to 30 mAh/cm².

8. The anode electrode of claim 1, wherein a thickness of the anode active material layer is in a range from 10 μm to 200 μm.

9. The anode electrode of claim 1, wherein the solid electrolyte is selected from a group consisting of sulfide-based solid electrolyte, halide-based solid electrolyte, and hydride-based solid electrolyte.

10. The anode electrode of claim 1, wherein the solid electrolyte comprises sulfide solid electrolyte.

11. The anode electrode of claim 10, wherein the sulfide solid electrolyte is selected from a group consisting of pseudobinary sulfide, pseudoternary sulfide, and pseudoquaternary sulfide.

12. The anode electrode of claim 1, wherein the anode active material layer comprises 70 wt % to 98 wt % of the anode active material layer, the solid electrolyte comprises 2 wt % to 30 wt % of the anode active material layer, and the fibrillating binder comprises 0.1 wt % to 5 wt % of the anode active material layer.

13. An anode electrode for a battery cell, comprising:
an anode current collector; and
an anode active material layer arranged on the anode current collector, wherein the anode active material layer includes:
an anode active material selected from a group consisting of silicon, silicon alloy, and silicon/silicon oxide;
an outer coating layer covering at least a portion of an outer surface of particles of the anode active material layer,
wherein the outer coating layer includes a solid electrolyte selected from a group consisting of sulfide-based solid electrolyte, halide-based solid electrolyte, and hydride-based solid electrolyte; and
a fibrillating binder comprising polytetrafluoroethylene (PTFE).

14. The anode electrode of claim 13, wherein loading of the anode active material layer is in a range from 4 mAh/cm² to 30 mAh/cm².

15. The anode electrode of claim 13, wherein a thickness of the anode active material layer is in a range from 10 μm to 200 μm.

16. The anode electrode of claim 13, wherein:
the solid electrolyte comprises sulfide solid electrolyte, and
the sulfide solid electrolyte is selected from a group consisting of pseudobinary sulfide, pseudoternary sulfide, and pseudoquaternary sulfide.

17. The anode electrode of claim 13, wherein the anode active material layer comprises 70 wt % to 98 wt % of the anode active material layer, the solid electrolyte comprises 2 wt % to 30 wt % of the anode active material layer, and the fibrillating binder comprises 0.1 wt % to 5 wt % of the anode active material layer.

18. A method for manufacturing anode electrode for a battery cell, comprising:
mixing and milling a pre-mixture including:
particles of an anode active material selected from a group consisting of silicon, silicon alloy, and silicon/silicon oxide, and
particles of a solid electrolyte selected from a group consisting of sulfide-based solid electrolyte, halide-based solid electrolyte, and hydride-based solid electrolyte;
wherein the particles of the solid electrolyte at least partially coat the particles of the anode active material;
adding a fibrillating binder to the pre-mixture;
mixing and shearing the pre-mixture to create fibrils of the fibrillating binding and to create a mixture for an anode active material layer; and
one of:
pressing the mixture to create a free-standing anode active material layer, and
casting the mixture onto an anode current collector to form the anode active material layer of the anode electrode.

19. The method of claim 18, wherein:
the solid electrolyte comprises sulfide solid electrolyte, and
the sulfide solid electrolyte is selected from a group consisting of pseudobinary sulfide, pseudoternary sulfide, and pseudoquaternary sulfide.

20. The method of claim 18, wherein the anode active material layer comprises 70 wt % to 98 wt % of the anode active material layer, the solid electrolyte comprises 2 wt % to 30 wt % of the anode active material layer, and the fibrillating binder comprises 0.1 wt % to 5 wt % of the anode active material layer.
